(19) United States
(12) Patent Application Publication
(10) Pub. No.: US 2019/0162836 A1
(43) Pub. Date: May 30, 2019

(54) METHOD AND APPARATUS FOR IMPROVED RADAR TARGET TRACKING WITH POWER INFORMATION

(71) Applicant: GM GLOBAL TECHNOLOGY OPERATIONS LLC, Detroit, MI (US)

(72) Inventors: Igal Bilik, Rehovot (IL); Alexander Pokrass, Bat Yam (IL); Ishai Eljarat, Raanana (IL)

(21) Appl. No.: 15/822,321

(22) Filed: Nov. 27, 2017

(51) Int. Cl. G01S 13/42; G01S 13/93; G01S 13/89

(52) U.S. Cl. CPC G01S 13/426; G01S 13/89; G01S 13/931

(57) ABSTRACT

Methods and systems are provided for controlling a radar system of a vehicle. In particular a method and apparatus are taught for a predictive tracking algorithm for predicting the power of a target cluster for the next frame and determining a predicted cluster power for the next frame. The updated power of the next cluster frame is a function of the predicted power, the current measured power and the SNR of the environment. The power of cluster is computed taking into account the energy backscattered by each detection inside the cluster.

### TECHNICAL FIELD

The present disclosure generally relates to vehicles, and more particularly relates to methods and radar systems for tracking information based on adaptive detectors.

### BACKGROUND

Certain vehicles today utilize radar systems. For example, certain vehicles utilize radar systems to detect other vehicles, pedestrians, or other objects on a road in which the vehicle is travelling. Radar systems may be used in this manner, for example, in implementing automatic braking systems, adaptive cruise control, and avoidance features, among other vehicle features. Conventional detectors are memory-less and not take into account the information from previous frame. These detectors employ detection thresholds based only in the signal-to-noise ratio (SNR) and its level doesn't depend on the targets surroundings both spatially and temporally. While these radar detectors are generally useful for such vehicle features, in certain situations existing radar systems may have certain limitations.

Accordingly, it is desirable to provide improved techniques for radar system performance in vehicles, for example to include the information of the previous frame to adaptively change the threshold and thus to increase the probability of detecting tracked targets. It is further desirable to increase the detectability of weaker backscatter radar signals. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided for controlling a radar system of a vehicle, the radar system having a plurality of receivers. The method comprises receiving a first range Doppler map, detecting an object in response to the first range Doppler map to generate an object signal using a first threshold wherein the first threshold is determined in response to a signal to noise ratio, generating a cluster signal in response to the object signal, determining a track state in response to the cluster signal, updating the first threshold in response to the track state and the signal to noise ratio to generate an updated threshold, and detecting the object in response to a second range Doppler map in response to the updated threshold.

In accordance with an exemplary embodiment, a radar control system for a vehicle is provided. The apparatus comprises a detector for receiving a first range Doppler map and detecting an object in response to the first range Doppler map to generate an object signal using a first threshold wherein the first threshold is determined in response to a signal to noise ratio, a cluster processor for generating a cluster signal in response to the object signal, a tracking processor for determining a track state in response to the cluster signal and a threshold computer for updating the first threshold in response to the track state and the signal to noise ratio to generate an updated threshold wherein the updated threshold is used for detecting the object in a subsequent range Doppler map.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle having a control system, including a radar system, in accordance with an exemplary embodiment.

FIG. 2 is a functional block diagram of the control system of the vehicle of FIG. 1, including the radar system, in accordance with an exemplary embodiment.

FIG. 3 is a functional block diagram of a transmission channel and a receiving channel of the radar system of FIGS. 1 and 2, in accordance with an exemplary embodiment.

FIG. 4 provides a block diagram of an apparatus for adaptive radar detection based on tracking information in accordance with an exemplary embodiment.

FIG. 5 provides a flow diagram corresponding to implementation of the method for adaptive radar detection based on tracking information in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

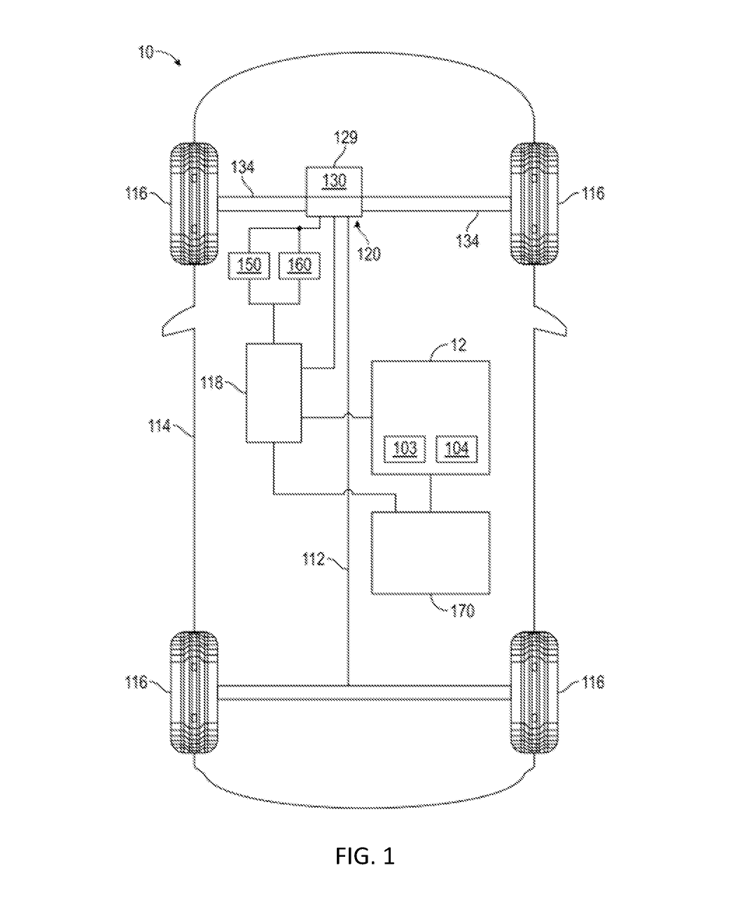

FIG. 1 provides a functional block diagram of vehicle 10, in accordance with an exemplary embodiment. As described in further detail greater below, the vehicle 10 includes a radar control system 12 having a radar system 103 and a controller 104 that classifies objects based upon a three dimensional representation of the objects using received radar signals of the radar system 103.

In the depicted embodiment, the vehicle 10 also includes a chassis 112, a body 114, four wheels 116, an electronic control system 118, a steering system 150, and a braking system 160. The body 114 is arranged on the chassis 112 and substantially encloses the other components of the vehicle 10. The body 114 and the chassis 112 may jointly form a frame. The wheels 116 are each rotationally coupled to the chassis 112 near a respective corner of the body 114.

In the exemplary embodiment illustrated in FIG. 1, the vehicle 10 includes an actuator assembly 120. The actuator assembly 120 includes at least one propulsion system 129 mounted on the chassis 112 that drives the wheels 116. In the depicted embodiment, the actuator assembly 120 includes an engine 130. In one embodiment, the engine 130 comprises a combustion engine. In other embodiments, the actuator assembly 120 may include one or more other types of engines and/or motors, such as an electric motor/generator, instead of or in addition to the combustion engine.

Still referring to FIG. 1, the engine 130 is coupled to at least some of the wheels 116 through one or more drive shafts 134. In some embodiments, the engine 130 is also mechanically coupled to a transmission. In other embodiments, the engine 130 may instead be coupled to a generator used to power an electric motor that is mechanically coupled to a transmission.

The steering system 150 is mounted on the chassis 112, and controls steering of the wheels 116. The steering system 150 includes a steering wheel and a steering column (not depicted). The steering wheel receives inputs from a driver of the vehicle 10. The steering column results in desired steering angles for the wheels 116 via the drive shafts 134 based on the inputs from the driver.

The braking system 160 is mounted on the chassis 112, and provides braking for the vehicle 10. The braking system 160 receives inputs from the driver via a brake pedal (not depicted), and provides appropriate braking via brake units (also not depicted). The driver also provides inputs via an accelerator pedal (not depicted) as to a desired speed or acceleration of the vehicle 10, as well as various other inputs for various vehicle devices and/or systems, such as one or more vehicle radios, other entertainment or infotainment systems, environmental control systems, lightning units, navigation systems, and the like (not depicted in FIG. 1).

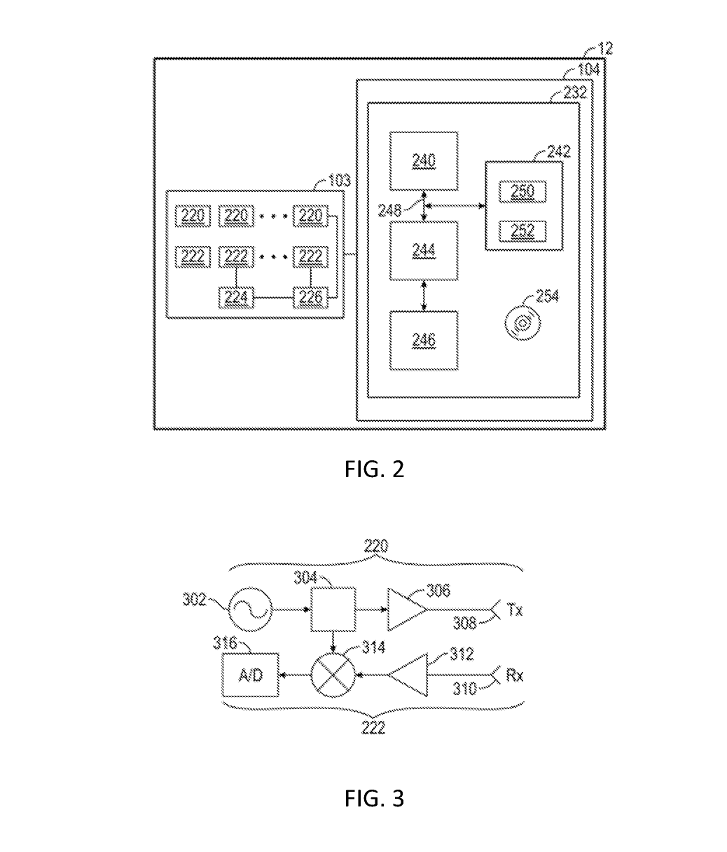

Also as depicted in FIG. 1, in certain embodiments the vehicle 10 may also include a telematics system 170. In one such embodiment the telematics system 170 is an onboard device that provides a variety of services through communication with a call center (not depicted) remote from the vehicle 10. In various embodiments the telematics system may include, among other features, various non-depicted features such as an electronic processing device, one or more types of electronic memory, a cellular chipset/component, a wireless modem, a dual mode antenna, and a navigation unit containing a GPS chipset/component. In certain embodiments, certain of such components may be included in the controller 104, for example as discussed further below in connection with FIG. 2. The telematics system 170 may provide various services including: turn-by-turn directions and other navigation-related services provided in conjunction with the GPS chipset/component, airbag deployment notification and other emergency or roadside assistance-related services provided in connection with various sensors and/or sensor interface modules located throughout the vehicle, and/or infotainment-related services such as music, internet web pages, movies, television programs, videogames, and/or other content.

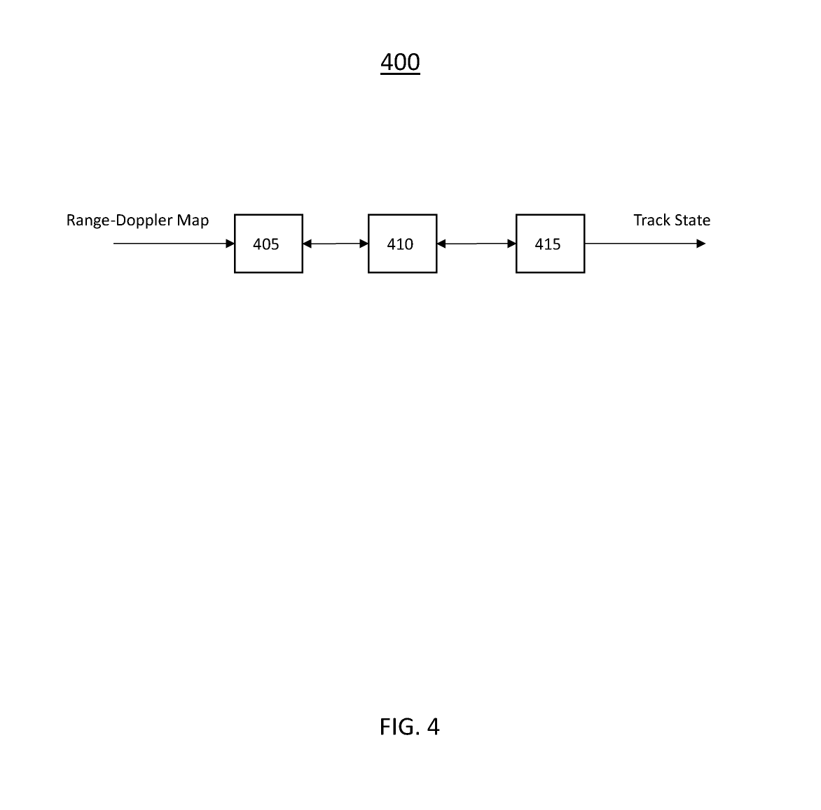

The radar control system 12 is mounted on the chassis 112. As mentioned above, the radar control system 12 classifies objects based upon a three dimensional representation of the objects using received radar signals of the radar system 103. In one example, the radar control system 12 provides these functions in accordance with the method 400 described further below in connection with FIG. 4.

While the radar control system 12, the radar system 103, and the controller 104 are depicted as being part of the same system, it will be appreciated that in certain embodiments these features may comprise two or more systems. In addition, in various embodiments the radar control system 12 may comprise all or part of, and/or may be coupled to, various other vehicle devices and systems, such as, among others, the actuator assembly 120, and/or the electronic control system 118.

With reference to FIG. 2, a functional block diagram is provided for the radar control system 12 of FIG. 1, in accordance with an exemplary embodiment. As noted above, the radar control system 12 includes the radar system 103 and the controller 104 of FIG. 1.

As depicted in FIG. 2, the radar system 103 includes one or more transmitters 220, one or more receivers 222, a memory 224, and a processing unit 226. In the depicted embodiment, the radar system 103 comprises a multiple input, multiple output (MIMO) radar system with multiple transmitters (also referred to herein as transmission channels) 220 and multiple receivers (also referred to herein as receiving channels) 222. The transmitters 220 transmit radar signals for the radar system 103. After the transmitted radar signals contact one or more objects on or near a road on which the vehicle 10 is travelling and is reflected/redirected toward the radar system 103, the redirected radar signals are received by the receivers 222 of the radar system 103 for processing.

With reference to FIG. 3, a representative one of the transmission channels 220 is depicted along with a respective one of the receiving channels 222 of the radar system of FIG. 3, in accordance with an exemplary embodiment. As depicted in FIG. 3, each transmitting channel 220 includes a signal generator 302, a filter 304, an amplifier 306, and an antenna 308. Also as depicted in FIG. 3, each receiving channel 222 includes an antenna 310, an amplifier 312, a mixer 314, and a sampler/digitizer 316. In certain embodiments the antennas 308, 310 may comprise a single antenna, while in other embodiments the antennas 308, 310 may comprise separate antennas. Similarly, in certain embodiments the amplifiers 306, 312 may comprise a single amplifier, while in other embodiments the amplifiers 306, 312 may comprise separate amplifiers. In addition, in certain embodiments multiple transmitting channels 220 may share one or more of the signal generators 302, filters 304, amplifiers 306, and/or antennae 308. Likewise, in certain embodiments, multiple receiving channels 222 may share one or more of the antennae 310, amplifiers 312, mixers 314, and/or samplers/digitizers 316.

The radar system 103 generates the transmittal radar signals via the signal generator(s) 302. The transmittal radar signals are filtered via the filter(s) 304, amplified via the amplifier(s) 306, and transmitted from the radar system 103 (and from the vehicle 10 to which the radar system 103 belongs, also referred to herein as the “host vehicle”) via the antenna(e) 308. The transmitting radar signals subsequently contact other vehicles and/or other objects on or alongside the road on which the host vehicle 10 is travelling. After contacting the other vehicles and/or other objects, the radar signals are reflected, and travel from the other vehicles and/or other objects in various directions, including some signals returning toward the host vehicle 10. The radar signals returning to the host vehicle 10 (also referred to herein as received radar signals) are received by the antenna(e) 310, amplified by the amplifier(s) 312, mixed by the mixer(s) 314, and digitized by the sampler(s)/digitizer(s) 316.

Returning to FIG. 2, the radar system 103 also includes, among other possible features, the memory 224 and the processing unit 226. The memory 224 stores information received by the receiver 222 and/or the processing unit 226. In certain embodiments, such functions may be performed, in whole or in part, by a memory 242 of a computer system 232 (discussed further below).

The processing unit 226 processes the information obtained by the receivers 222 for classification of objects based upon a three dimensional representation of the objects using received radar signals of the radar system 103. The processing unit 226 of the illustrated embodiment is capable of executing one or more programs (i.e., running software) to perform various tasks instructions encoded in the program(s). The processing unit 226 may include one or more microprocessors, microcontrollers, application specific integrated circuits (ASICs), or other suitable device as realized by those skilled in the art, such as, by way of example, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

In certain embodiments, the radar system 103 may include multiple memories 224 and/or processing units 226, working together or separately, as is also realized by those skilled in the art. In addition, it is noted that in certain embodiments, the functions of the memory 224, and/or the processing unit 226 may be performed in whole or in part by one or more other memories, interfaces, and/or processors disposed outside the radar system 103, such as the memory 242 and the processor 240 of the controller 104 described further below.

As depicted in FIG. 2, the controller 104 is coupled to the radar system 103. Similar to the discussion above, in certain embodiments the controller 104 may be disposed in whole or in part within or as part of the radar system 103. In addition, in certain embodiments, the controller 104 is also coupled to one or more other vehicle systems (such as the electronic control system 118 of FIG. 1). The controller 104 receives and processes the information sensed or determined from the radar system 103, provides detection, classification, and tracking of based upon a three dimensional representation of the objects using received radar signals of the radar system 103, and implements appropriate vehicle actions based on this information. The controller 104 generally performs these functions in accordance with the method 400 discussed further below in connection with FIGS. 4-6.

As depicted in FIG. 2, the controller 104 comprises the computer system 232. In certain embodiments, the controller 104 may also include the radar system 103, one or more components thereof, and/or one or more other systems. In addition, it will be appreciated that the controller 104 may otherwise differ from the embodiment depicted in FIG. 2. For example, the controller 104 may be coupled to or may otherwise utilize one or more remote computer systems and/or other control systems, such as the electronic control system 118 of FIG. 1.

As depicted in FIG. 2, the computer system 232 includes the processor 240, the memory 242, an interface 244, a storage device 246, and a bus 248. The processor 240 performs the computation and control functions of the controller 104, and may comprise any type of processor or multiple processors, single integrated circuits such as a microprocessor, or any suitable number of integrated circuit devices and/or circuit boards working in cooperation to accomplish the functions of a processing unit. In one embodiment, the processor 240 classifies objects using radar signal spectrogram data in combination with one or more computer vision models. During operation, the processor 240 executes one or more programs 250 contained within the memory 242 and, as such, controls the general operation of the controller 104 and the computer system 232, generally in executing the processes described herein, such as those of the method 400 described further below in connection with FIGS. 4-6.

The memory 242 can be any type of suitable memory. This would include the various types of dynamic random access memory (DRAM) such as SDRAM, the various types of static RAM (SRAM), and the various types of non-volatile memory (PROM, EPROM, and flash). In certain examples, the memory 242 is located on and/or co-located on the same computer chip as the processor 240. In the depicted embodiment, the memory 242 stores the above-referenced program 250 along with one or more stored values 252 (such as, by way of example, information from the received radar signals and the spectrograms therefrom).

The bus 248 serves to transmit programs, data, status and other information or signals between the various components of the computer system 232. The interface 244 allows communication to the computer system 232, for example from a system driver and/or another computer system, and can be implemented using any suitable method and apparatus. The interface 244 can include one or more network interfaces to communicate with other systems or components. In one embodiment, the interface 244 includes a transceiver. The interface 244 may also include one or more network interfaces to communicate with technicians, and/or one or more storage interfaces to connect to storage apparatuses, such as the storage device 246.

The storage device 246 can be any suitable type of storage apparatus, including direct access storage devices such as hard disk drives, flash systems, floppy disk drives and optical disk drives. In one exemplary embodiment, the storage device 246 comprises a program product from which memory 242 can receive a program 250 that executes one or more embodiments of one or more processes of the present disclosure, such as the method 400 (and any sub-processes thereof) described further below in connection with FIGS. 4-6. In another exemplary embodiment, the program product may be directly stored in and/or otherwise accessed by the memory 242 and/or a disk (e.g., disk 254), such as that referenced below.

The bus 248 can be any suitable physical or logical means of connecting computer systems and components. This includes, but is not limited to, direct hard-wired connections, fiber optics, infrared and wireless bus technologies. During operation, the program 250 is stored in the memory 242 and executed by the processor 240.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 240) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system 232 may also otherwise differ from the embodiment depicted in FIG. 2, for example in that the computer system 232 may be coupled to or may otherwise utilize one or more remote computer systems and/or other control systems.

Turning now to FIG. 4, an exemplary apparatus for radar detection with improved target tracking with power information 400 according is shown. The apparatus includes a detector 405, a clustering processor 410 and a tracking processor 415. Previously the tracking processor used cluster parameters for tracking which were used independently of the signal-to-noise ratio (SNR). However, taking into account the power information and SNR improves the reliability of the measurements.

The currently disclosed tracking algorithm predicts the power of the cluster for the next frame and uses this information with the SNR. Initially a Range-Doppler map is the input for the detector 405 running the detector algorithm and the threshold is calculated on the SNR conditions or the radar noise floor.

The clustering processor 410 is operative to compute the cluster power Pₖ by adding the power from each detector that belongs to a cluster. A method determines the cluster center, for example, the center of mass of the detection in a four dimensional space (x,y,z,Doppler) using energy as weight. Power Pₖ is then associated with the cluster centroid. The power of cluster in frame (k−1) is known as Pₖ₋₁. To update the power for frame k, the method is operative to predict the power P′ₖ=Pₖ₋₁. The method then performs the power measurement Pₘₑₐₛ_{_}ₖ and then computes Pₖ=f(SNRₖ,P′ₖ, Pₘₑₐₛ_{_}ₖ).

The updated power is a function of the predicted power, the current power measured and the SNR of the environment. Power of cluster is computed taking into account the energy backscattered by each detection inside it. By using the power information we increase the reliability of the tracking algorithm. It is possible to separate clusters that are on the same position and Doppler by making use of the cluster power. It is possible to sort targets according to their power

By using the power information to compute the cluster power, the method increases the reliability of the tracking algorithm. It is possible to separate clusters that are on the same position and Doppler by making use of the cluster power and to targets according to their power. After the clustering processor 410 computes clusters and the tracking processor 415 processes track states, the information about each detection is used to define the threshold that will be used for the detector in the next frame and the location which this detection will be applied.

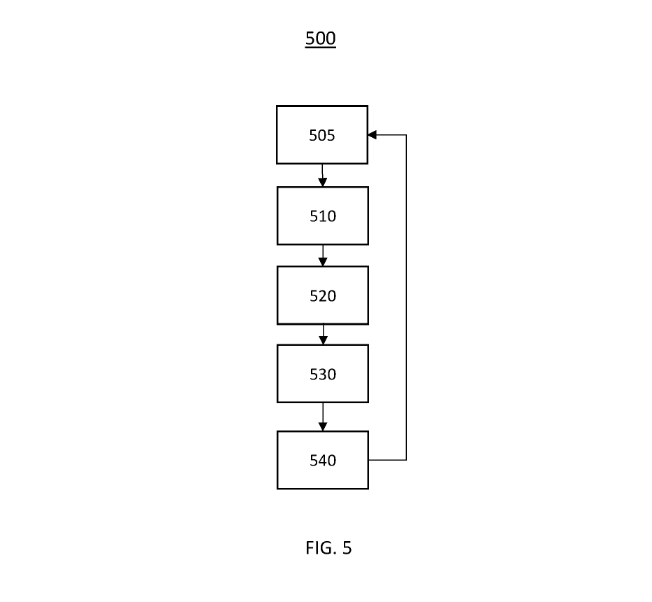

Turning now to FIG. 5 a method for adaptive radar detection based on tracking information 500 is shown. The method is first operative to receive a range Doppler map 505. A method then determines object detection including position in three dimensional space (x,y,z) Doppler, and amplitude at a frame k using a threshold calculated using the SNR conditions 510. The method is then operative to compute a cluster power by summing the measured amplitude from each detection belonging to a cluster at frame k 520. The method is then operative to update the cluster power in response to the computed cluster power at frame k and a cluster predicted power from a previous frame k−1 530. The updated cluster power is then used to determine the track state and, optionally, the updated cluster power is used to update the threshold used by the detector for detection operations 540.

It will be appreciated that the disclosed methods, systems, and vehicles may vary from those depicted in the Figures and described herein. For example, the vehicle 10, the radar control system 12, the radar system 103, the controller 104, and/or various components thereof may vary from that depicted in FIGS. 1-3 and described in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

1. A method comprising:
transmitting a first radar signal;
receiving a reflection of the first radar signal;
detecting a first cluster in response to the reflection of the first radar signal;
determine a first cluster power in response to the first cluster;
transmit a second radar signal;
receive a reflection of the second radar signal;
detecting a second cluster in response to the reflection of the second radar signal;
determine a second cluster power in response to the second cluster;
compute an updated cluster power in response to the first cluster power and the second cluster power; and
tracking the second cluster in response to the updated cluster power.

2. The method of claim 1 wherein the updated cluster power is further computed in response to a signal to noise ratio.

3. The method of claim 1 wherein the first cluster power is determined in response the power from each detection of the first cluster.

4. The method of claim 1 further comprising determining a cluster center of the first cluster in response to a center of mass detection in a three dimensional space and a Doppler value.

5. The method of claim 1 further comprising generating a cluster map in response to the tracking of the second cluster.

6. The method of claim 1 wherein the updated cluster power is a function of a predicted power, a currently measured power, and a signal to noise ratio of an environment.

7. The method of claim 1 further comprising generating a threshold in response to the first cluster power and detecting the second cluster in response to the threshold.

8. The method of claim 1 further comprising generating a threshold in response to the first cluster power and a signal to noise ratio and detecting a second cluster in response to the threshold.

9. The method of claim 1 further comprising generating a radar map in response to the updated cluster power.

10. The method of claim 1 further comprising generating a control signal for controlling an autonomous vehicle in response to the tracking of the second cluster.

11. An apparatus comprising:
A transmitter for transmitting a first radar signal and a second radar signal;
A receiver for receiving a reflection of the first radar signal and a reflection of the second radar signal;
A detector for detecting a first cluster in response to the reflection of the first radar signal and a second cluster in response to the reflection of the second radar signal;
A processor for determine a first cluster power in response to the first cluster, a second cluster power in response to the second cluster, the processor further operative to compute an updated cluster power in response to the first cluster power and the second cluster power; and
A tracker for tracking the second cluster in response to the updated cluster power.

12. The apparatus if claim 11 wherein the updated cluster power is further computed in response to a signal to noise ratio.

13. The apparatus if claim 11 wherein the first cluster power is determined in response the power from each detection of the first cluster.

14. The apparatus if claim 11 further comprising determining a cluster center of the first cluster in response to a center of mass detection in a three dimensional space and a Doppler value.

15. The apparatus if claim 11 further comprising generating a cluster map in response to the tracking of the second cluster.

16. The apparatus if claim 11 wherein the updated cluster power is a function of a predicted power, a currently measured power, and a signal to noise ratio of an environment.

17. The apparatus if claim 11 further comprising generating a threshold in response to the first cluster power and detecting the second cluster in response to the threshold.

18. The apparatus if claim 11 further comprising generating a threshold in response to the first cluster power and a signal to noise ratio and detecting a second cluster in response to the threshold.

19. The apparatus if claim 11 further comprising generating a radar map in response to the updated cluster power.

20. The apparatus if claim 11 further comprising generating a control signal for controlling an autonomous vehicle in response to the tracking of the second cluster.
